(19) United States
(12) Patent Application Publication
(10) Pub. No.: US 2021/0304501 A1
(43) Pub. Date: Sep. 30, 2021

(54) Systems and Methods for Facilitating a Virtual Preview of a Visual Appearance of a Customized Hearing Device

(71) Applicant: SONOVA AG, Staefa (CH)

(72) Inventors: Nathalie Leuthold, Stäfa (CH); Jana-Kosima Schwarzlos-Sooprayen, Stäfa (CH)

(73) Assignee: Sonova AG

(21) Appl. No.: 16/829,955

(22) Filed: Mar. 25, 2020

(51) Int. Cl. G06T 19/00; G06F 3/0481; G06T 15/00

(52) U.S. Cl. CPC G06T 19/006; G06T 2200/24; G06T 15/005; G06F 3/04817

(57) ABSTRACT

An exemplary system is configured to generate a three-dimensional (3D) scan of an ear of a user, obtain a hearing loss profile of the user, generate, based on the 3D scan of the ear of the user and the hearing loss profile of the user, a virtual representation of a customized hearing device for the user, and provide, for display to the user by way of a display device, a live preview image that includes the virtual representation of the customized hearing device and that demonstrates how the customized hearing device would appear when worn by the user.

### BACKGROUND INFORMATION

Hearing devices (e.g., hearing aids) are used to improve the hearing capability and/or communication capability of users. Such hearing devices are configured to process a received input sound signal (e.g., ambient sound) and then provide the processed input sound signal to the user (e.g., by way of a receiver (e.g., a speaker) placed in the user's ear canal or at any other suitable location). In addition, such hearing devices are typically customized for a user based on various factors associated with the user such as the user's particular hearing loss characteristics, the desired components of the customized hearing device, aesthetic preferences of the user, and/or the amount of ear space (e.g., within an ear canal of the user) available to receive the customized hearing device.

During a selection process in which a customized hearing device is selected to be manufactured for a user, an audiologist or the like may present various different models of hearing devices to the user that the user can see and touch. However, there are typically a limited number of models of hearing devices available to show a user. As such, the various models of hearing devices presented to the user during the selection process may not accurately represent the visual appearance that the customized hearing device will have after manufacture. For example, in instances where a customized hearing device includes an in-the-ear hearing device configured to fit at least partially within an ear canal of the user, the size of the user's ear canal may limit which components are able to fit within the portion of the hearing device that extends within the ear canal. In such examples, the components that are too large to fit within the portion that extends within the ear canal must be provided in a portion of the in-the-ear hearing device that extends outside of the ear canal. However, in so doing, the portion of the customized hearing device that is visible outside of the user's ear canal may be relatively larger than such a portion of a model of a hearing device shown during the selection process. Such a relatively larger visible portion may result in customer dissatisfaction because the user's expectation of how the customized hearing device should appear when worn does not match how the customized hearing device actually appears after manufacture.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary system according to principles described herein.

FIGS. 2 and 3 illustrate exemplary configurations in which the system of FIG. 1 may be implemented according to principles described herein.

FIGS. 4 and 5 illustrate exemplary live preview images that may be provided for display according to principles described herein.

FIG. 6 illustrates an exemplary image capture configuration that may be implemented according to principles described herein.

FIG. 7 illustrates an exemplary live preview image that may be provided for display according to principles described herein.

FIG. 8 illustrates an exemplary method for facilitating a virtual preview of a visual appearance of a customized hearing device according to principles described herein.

FIG. 9 illustrates an exemplary computing device according to principles described herein.

### DETAILED DESCRIPTION

Systems and methods for facilitating a virtual preview of a visual appearance of a customized hearing device are described herein. As will be described in more detail below, an exemplary system comprises a memory storing instructions and a processor communicatively coupled to the memory. The processor may be configured to execute the instructions to generate a three-dimensional (3D) scan of an ear of a user, obtain a hearing loss profile of the user, generate, based on the 3D scan of the ear of the user and the hearing loss profile of the user, a virtual representation of a customized hearing device for the user, and provide, for display to the user by way of a display device, a live preview image that includes the virtual representation of the customized hearing device and that demonstrates how the customized hearing device would appear when worn by the user.

By providing systems and methods such as those described herein, it is possible to virtually show a user how a customized hearing device would look on his/her own ear prior to manufacturing the customized hearing device. In so doing, systems and methods such as those described herein may be able to improve customer satisfaction by ensuring that the user's expectation of how the customized hearing device should appear when worn matches how the customized hearing device actually appears after manufacture. This in turn may result in lower remake rates of customized hearing devices due to customer dissatisfaction. Moreover, systems and methods such as those described herein may facilitate a user visualizing aesthetic compromises and/or functional trade-offs that may occur when selecting certain components to be included as part of a customized hearing device. Other benefits of the systems and methods described herein will be made apparent herein.

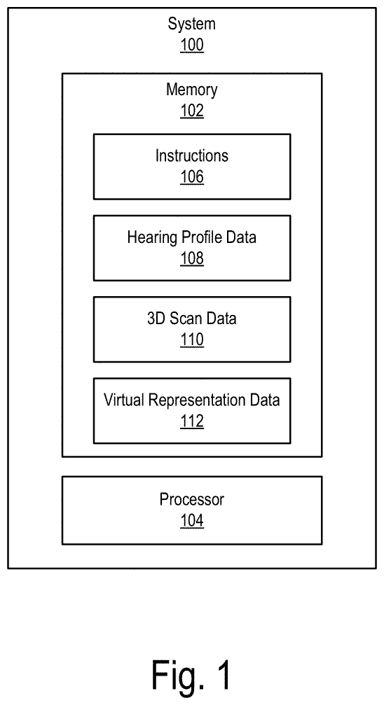

FIG. 1 illustrates an exemplary system 100 that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and processor 104 may be distributed between multiple devices (e.g., multiple computing devices) and/or multiple locations as may serve a particular implementation.

Memory 102 may maintain (e.g., store) executable data used by processor 104 to perform any of the operations associated with facilitating a virtual preview of a visual appearance of a customized hearing device. For example, memory 102 may store instructions 106 that may be executed by processor 104 to perform any of the operations associated with system 100 described herein. Instructions 106 may be implemented by any suitable application, software, code, and/or other executable data instance.

As shown in FIG. 1, memory 102 may also store hearing profile data 108 that may include any suitable data associated with hearing loss characteristics of a user of a hearing device and options associated with a hearing device to be manufactured for the user. For example, hearing profile data 108 may include any suitable information associated with a hearing loss profile of a particular user. In addition, hearing profile data 108 may include any suitable data that specifies components to be included in a customized hearing device, user-selected component options for the customized hearing device, user-selected color options for a customized hearing device, and/or any other suitable information.

As shown in FIG. 1, memory 102 may also store 3D scan data 110 that may include any data associated with physical attributes of an ear of a user. For example, 3D scan data 110 may include data that defines dimensions of cavities (e.g., space within an ear canal, space between the pinna and the head of the user, etc.) of an ear where a hearing device may be worn by a user. Examples of how system 100 may obtain 3D scan data 110 are described herein.

As shown in FIG. 1, memory 102 may also store virtual representation data 112 that may include any suitable information usable to virtually depict how a customized hearing device will appear when worn by a user. For example, virtual representation data 112 may include any suitable information associated with one or more virtual representations of customized hearing devices that may be provided for display to a user. Virtual representation data 112 may also include any suitable information, instructions, graphical interface content, etc. to facilitate presentation of one or more virtual representations of customized hearing devices. For example, virtual representation data 112 may include user selectable icons usable to switch display of virtual representations of customized hearing devices. Examples of virtual representations of customized hearing devices will be described herein.

Memory 102 may also maintain any data received, generated, managed, used, and/or transmitted by processor 104. For example, memory 102 may maintain any data suitable to facilitate communications (e.g., wired and/or wireless communications) between system 100 and one or more additional computing devices, such as those described herein. Memory 102 may maintain additional or alternative data in other implementations.

Processor 104 is configured to perform any suitable processing operation that may be associated with system 100. For example, processor 104 may be configured to perform (e.g., execute instructions 106 stored in memory 102 to perform) various processing operations associated with facilitating a virtual preview of a visual appearance of a customized hearing device. Such processing operations may include generating or otherwise obtaining a virtual representation of a customized hearing device to facilitate the user previewing how the customized hearing device would appear when worn by the user. For example, processor 104 may generate a 3D scan of an ear of a user, obtain a hearing loss profile of the user, generate, based on the 3D scan of the ear of the user and the hearing loss profile of the user, a virtual representation of a customized hearing device for the user, and provide, for display to the user by way of a display device, a live preview image that includes the virtual representation of the customized hearing device and that demonstrates how the customized hearing device would appear when worn by the user. These and other operations that may be performed by processor 104 are described herein.

Prospective users of hearing devices have different hearing loss characteristics, ear shape characteristics, hearing device component preferences, color preferences, etc. that need to be considered prior to manufacture of the hearing devices. In view of this, hearing devices are typically custom made for each user based on their individual characteristics and/or preferences. As used herein, a “customized hearing device” may be implemented by any device that is custom made for a particular user and that is configured to provide or enhance hearing to a user. For example, a customized hearing device may be implemented by one or more hearing aids configured to amplify audio content to a user, a sound processor included in a cochlear implant system configured to apply electrical stimulation representative of audio content to a user, a sound processor included in a stimulation system configured to apply electrical and acoustic stimulation to a user, or any other suitable hearing prosthesis or combination of hearing prostheses. In some examples, a customized hearing device may be implemented by an in-the-ear (“ITE”) component configured to be worn at least partially within an ear canal of a user. In some examples, a customized hearing device may be implemented by a behind-the-ear (“BTE”) component configured to be worn behind an ear of a user. In some examples, a customized hearing device may include a combination of an ITE component, a BTE component, and/or any other suitable component.

A prospective user of a customized hearing device may want to minimize how visible the customized hearing device is while worn and maximize the functionality of the customized hearing device. However, there are various factors that may affect the visual appearance (e.g., size, shape, etc.) that a customized hearing device has when worn by a user. For example, the specific shape, contours, and/or recesses of an ear of a user may limit how much of a customized hearing device may be hidden by the ear. For example, a user with a relatively large space behind the user's ear may be able hide a BTE component more easily than another user that has a relatively small space in that same location. In addition, the number of components included as part of a customized hearing device may increase the overall size of the customized hearing device, which may make the customized hearing device more visible. For example, a user may desire to have a volume control dial on an externally facing surface of an ITE component. However, such a volume control dial may increase the overall size of the portion of the ITE component that is visible while worn by the user. Further, hearing loss characteristics of a particular user may affect how large a customized hearing device appears in relation to an ear of the user. For example, a user's particular hearing loss characteristics may require that an ITE component of a customized hearing device include a vent, which may increase the size of the portion of ITE component that is visible.

In view of factors such as those described above, the size and/or shape of different customized hearing devices that may be made for a given user may vary significantly depending on the particular components to be included in the customized hearing devices. To manage a user's expectations regarding the relative size and/or shape that a customized hearing device will have in relation to the user's ear/head, it is desirable to provide the user with a virtual preview of how the customized hearing device would appear while worn by the user. To that end, system 100 (e.g., processor 104) may perform various operations associated with generating a virtual representation of a customized hearing device to be provided for display to a user. As used herein, a “virtual representation of a customized hearing device” may correspond to any suitable image, graphic, or animation that may be used to indicate a visual appearance of a customized hearing device. A virtual representation of a customized hearing device may have any suitable shape, size, and/or visual appearance as may serve a particular implementation. For example, a virtual representation of a customized hearing device may be transparent, opaque, colored, and/or have a pattern. In certain examples, a virtual representation of a customized hearing device may have a 3D appearance when displayed by a display device. In some examples, a virtual representation of a customized hearing device may be a realistic representation of the customized hearing device (e.g., may have the same visual appearance as the customized hearing device represented by the virtual representation).

The visual appearance that a virtual representation of a customized hearing device may have in a particular implementation may be defined by virtual representation 112 data stored by storage facility 102. Such virtual representation data 112 may include any data associated with a virtual representation of a customized hearing device. For example, the virtual representation data 112 stored in storage facility 102 may indicate that the virtual representations are to have a particular color, size, shape, etc. In certain examples, system 100 may provide one or more user interfaces that allow a user to adjust any suitable settings associated with a virtual representation of a customized hearing device. For example, the one or more user interfaces may allow the user to adjust the visual appearance (e.g., color, included components, etc.) of a virtual representation of a customized hearing device.

In certain examples, a virtual representation of a customized hearing device may include a virtual representation of an ITE component that is configured to be inserted at least partially within an ear canal of a user. In certain examples, a virtual representation of a customized hearing device may include a BTE component configured to be worn behind the ear of the user. In certain alternative operations, a virtual representation of a customized hearing device may include both an ITE component and a BTE component. In certain examples, a virtual representation of a customized hearing device may include one or more canal locks that are configured to extend outside of the ear canal (e.g., to the concha) and that prevent an ITE component from moving out of the ear canal.

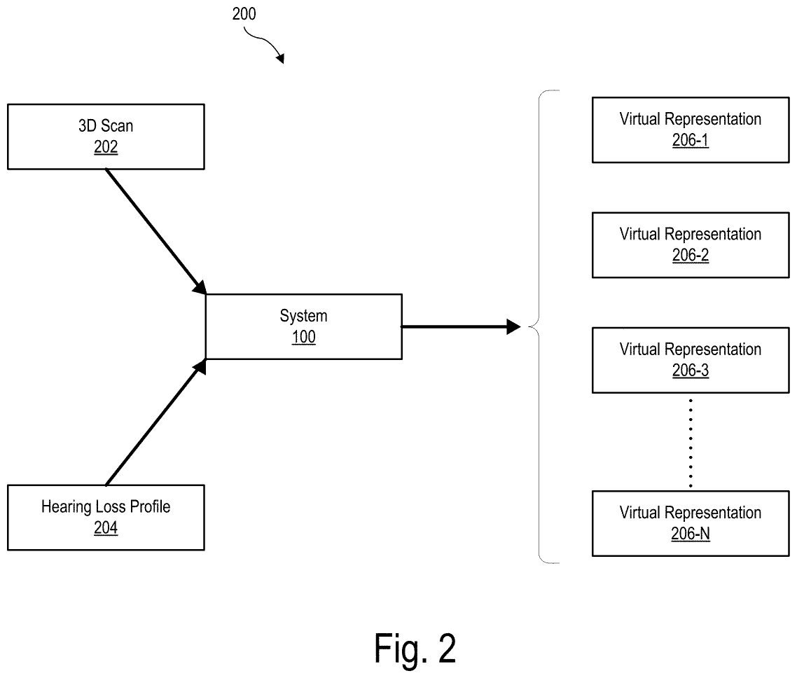

System 100 may generate a virtual representation of a customized hearing device in any suitable manner. To illustrate, FIG. 2 shows an exemplary configuration 200 in which system 100 may be implemented. As shown in FIG. 2, system 100 is configured to obtain a 3D scan 202 of an ear of a user and a hearing loss profile 204 of the user.

3D scan 202 may include any information that defines one or more spaces associated with an ear of a user where a customized hearing device may be worn by the user. For example, 3D scan 202 may define an available amount of space within an ear canal of the user where an ITE component of a customized hearing device may be inserted. Additionally or alternatively, 3D scan 202 may define an available amount of space between the pinna of the ear and the head of the user where a BTE component of a customized hearing device may be worn by the user. Additionally or alternatively, 3D scan 202 may define contours of the ear (e.g., in the concha) where one or more canal locks may be provided.

System 100 may obtain 3D scan 202 in any suitable manner. In certain implementations, system 100 may generate 3D scan 202 by directly scanning an ear of a user. For example, system 100 may use any suitable 3D scanning device to directly scan the recesses, contours, etc. of an ear of the user to generate 3D scan 202. In certain examples, system 100 may use a 3D scanner to directly scan inside an ear canal of the user. In such examples, 3D scan 202 may provide information indicating an amount of space available within the ear canal for a customized hearing device. Additionally or alternatively, system 100 may use a 3D scanner to directly scan the space behind an ear of a user (e.g., between the pinna of the ear and the head of the user). In such examples, 3D scan 202 may provide information indicating an amount of space available behind the ear of the user for a customized hearing device.

In certain alternative implementations, system 100 may generate 3D scan 202 by scanning an impression made of an ear of a user. For example, during a customized hearing device selection process, an audiologist or the like may insert a shape-forming material (e.g., silicone) into an ear canal of a user. The shape-forming material is configured to retain the shape defining the dimensions of the ear canal when removed from the ear canal. After the impression is removed from the ear canal, system 100 may use any suitable 3D scanner to 3D scan the impression to generate 3D scan 202.

Hearing loss profile 204 may include any suitable information that is associated with hearing loss characteristics of a user of a customized hearing device. In certain examples, hearing loss profile 204 may be represented by an audiogram of a user. In such examples, the information indicated in the audiogram of the user may be used to determine which components are to be included in the customized hearing device. For example, available component options for a customized hearing device may include a first receiver having a first size, a second receiver having a second size that is larger than the first size, and a third receiver having a third size that is larger than the second size. The information included in the audiogram of a user may be used to determine that the third receiver having the third size is needed based on the specific hearing loss characteristics of the user.

System 100 may obtain hearing loss profile 204 in any suitable manner. In certain examples, system 100 may generate hearing loss profile 204. For example, system 100 may use an audiometer communicatively coupled to system 100 to measure an audiogram of the user. Alternatively, system 100 may obtain the audiogram of the user in any suitable manner from a computing device external to system 100.

System 100 may use 3D scan 202 and hearing loss profile 204 in any suitable manner to generate a virtual representation of a customized hearing device. For example, based on 3D scan 202 and hearing loss profile 204, system 100 may determine one or more components to be included in the customized hearing device. In certain examples, system 100 may perform a modeling algorithm configured to automatically place the one or more components into a 3D shape defined at least in part by the information indicated by 3D scan 202. System 100 may then determine the size and/or shape of the virtual representation of the customized hearing device to accommodate the one or more components. To illustrate an example, based on 3D scan 202 and hearing loss profile 204, system 100 may determine that the customized hearing device should include a first component, a second component, and a third component. System 100 may use the modeling algorithm to determine that the first component and the second component will fit within a portion of an ITE component that is inserted within an ear canal of a user. However, system 100 may determine that the third component needs to be positioned on a surface of the ITE component that faces out of the ear canal. In view of this, system 100 may determine the size of the surface of the ITE component that faces outside of the ear canal accordingly to accommodate the third component. For example, based on hearing loss profile 204, system 100 may determine that a customized hearing device should include a vent. Accordingly, system 100 may select a shape and/or size of a virtual representation of a customized hearing device to accommodate the vent.

Additionally or alternatively, system 100 may select the shape and/or size of the virtual representation based at least in part on anatomical features of a user. For example, system 100 may select the shape and/or size of the virtual representation to accommodate the size of the receiver that is specific for the user. To illustrate, the size of the space available within an ear canal of a user may limit how many components may be included within the portion of the ITE component that is inserted within the ear canal. For example, if the user has a large (e.g., wide) ear canal, the receiver and/or other components may be provided within the portion of the ITE component that to be is inserted within the ear canal. Accordingly, system 100 may select the size of the virtual representation based at least in part the large size of the ear canal. Alternatively, if the user has a small (e.g., narrow) ear canal, the receiver and/or other components may not fit within the portion of the ITE component that is inserted within the ear canal. Accordingly, system 100 may select the size of the virtual representation of the customized hearing device based on the small ear canal of the user.

In certain examples, system 100 may generate a virtual representation of a customized hearing device based, at least in part, on one or more additional components that are selectable by a user. For example, a user may optionally select that the customized hearing device include an on/off switch, a volume control dial, and/or any other suitable component. The inclusion of any the one or more additional components may increase the size of a customized hearing device. Additionally or alternatively, a user may optionally select a particular color of customized hearing device. Accordingly, system 100 may determine a color, size, and/or shape of a virtual representation of a customized hearing device also based on such additional components.

In certain examples, system 100 may determine a size and/or shape of a virtual representation of a customized hearing device based on previously generated virtual representations of customized hearing devices. This may be accomplished in any suitable manner. For example, system 100 may compare 3D scan 202 and hearing loss profile 204 of a first user to those of a second user for which a virtual representation has already been generated. If 3D scans 202 and hearing loss profiles 204 of the first and second user are sufficiently similar (e.g., the sizes of the ear canals are similar and similar components are to be included), system 100 may use the virtual representation generated for the second user to determine the size and/or shape of the virtual representation for the first user.

In certain examples, system 100 may generate a plurality of virtual representations of customized hearing devices. For example, as shown in FIG. 2, system 100 may, based on 3D data 202 and hearing profile data 204, generate virtual representations 206 (e.g., virtual representations 206-1 through 206-N). In certain examples, each of virtual representations 206 may correspond to a differently configured customized hearing device that may be manufactured for a given user. For example, virtual representation 206-1 may have a first size and/or shape, virtual representation 206-2 may have a second size and/or shape, and virtual representation 206-3 may have a third size and/or shape. The first size and/or shape may be different from the second and third sizes and/or shapes depending on various options that may be associated with the customized hearing devices represented by virtual representations 206. For example, the customized hearing device represented by virtual representation 206-2 may include a volume control dial whereas the customized hearing device represented by virtual representation 206-1 may not include a volume control dial. Accordingly, virtual representation 206-2 may be relatively larger than virtual representation 206-1.

In certain examples, system 100 use 3D data 202 and hearing profile data 204 to generate a virtual representation of a smallest possible customized hearing device for a particular user. In addition, system 100 may generate one or more additional virtual representations of customized hearing devices that are relatively larger due to additional components to be included as part of the customized hearing devices. In such examples, the one or more additional virtual representations may be used to illustrate trade-offs in aesthetics and/or functionality that may occur as a result of including such additional components.

In certain alternative implementations, each of virtual representations 206 shown in FIG. 2 may represent a different view that a single customized hearing device would have when worn by a user. For example, if the customized hearing device includes a BTE component, virtual representation 206-1 may correspond to a front view that the BTE component would have when worn behind the ear of the user. Virtual representation 206-2 may correspond to a top view that the BTE component would have when worn behind the ear of the user. Virtual representation 206-3 may correspond to a rear view that the BTE component would have when worn behind the ear of the user.

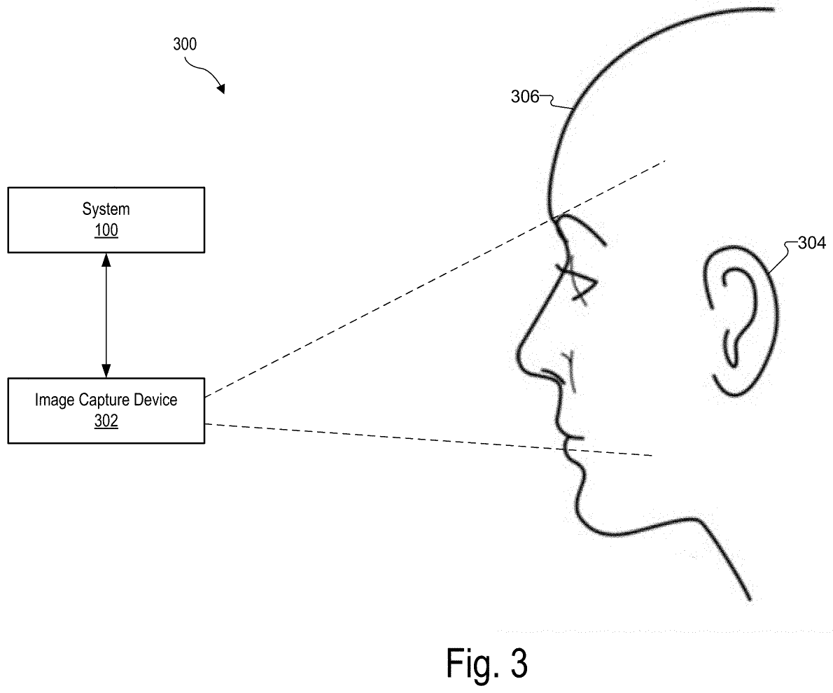

After system 100 generates a virtual representation of a customized hearing device, system 100 may provide the virtual representation for display to a user in any suitable manner. For example, system 100 may provide the virtual representation for display in a live preview image to demonstrate how the customized hearing device would appear when worn by the user. To that end, system 100 may be configured to instruct an imaging device to capture a live image of an ear of the user. To illustrate, FIG. 3 shows an exemplary configuration 300 in which system 100 is communicatively coupled, in any suitable manner, to an image capture device 302 that is configured to capture an image of an ear 304 of a user 306. Image capture device 302 may be configured to capture either still or video images of user 306. Image capture device 302 may correspond to any suitable image capture device (e.g., camera) that may be included as part of system 100 or that may be communicatively coupled to system 100. In certain examples, image capture device 302 may be provided separately from a display device used to display a virtual representation of a customized hearing device to a user.

In certain alternative examples, image capture device 302 may be included as part of a mobile computing device (e.g., a smartphone, a tablet computer, etc.) that may display a virtual representation of a customized hearing device together with an image captured by image capture device 302. In such examples, the mobile computing device may have a front facing camera such that user 306 may hold the mobile computing device up to capture an image the head of user 306 while viewing a display screen of the mobile computing device.

System 100 may provide a virtual representation of a customized hearing device to a display device in any suitable manner. For example, system 100 may use any suitable wireless communication protocol to transmit a virtual representation to a display device. In certain alternative implementations, system 100 may generate an indicator that is usable to access information associated with the virtual representation of the customized hearing device generated by system 100. For example, system 100 may generate a QR code that may indicate or otherwise be used to access any suitable information associated with the virtual representation. In such examples, system 100 may provide the indicator for display by way of any suitable display device associated with system 100. A user (e.g., user 306 or some other individual) of a mobile computing device may use a QR code scanning application on the mobile computing device to scan the QR code provided for display by system 100. The mobile computing device may then use information accessed by scanning the QR code to display the virtual representation of the customized hearing device together with a live image of an ear of the user.

System 100 may provide a virtual representation of a customized hearing device for display to a user in any suitable manner. For example, in certain implementations, system 100 may provide a virtual representation of a customized hearing device for display to a user in a live preview image. A live preview image may correspond to any suitable live image of a user that includes a virtual representation of a customized hearing device and that demonstrates how the customized hearing device would appear when worn by the user. System 100 may provide a live preview image for display by way of any suitable display device. For example, system 100 may provide a live preview image for display by way of a mobile computing device (e.g., a smartphone, a tablet computer, etc.), a laptop computer, a desktop computer, and/or any other suitable display device.

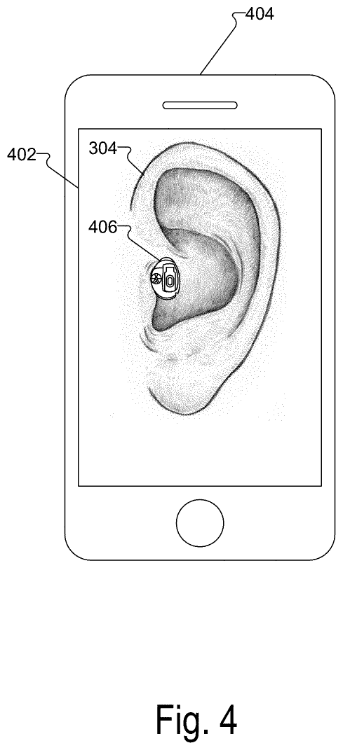

To illustrate an example, FIG. 4 shows an exemplary live preview image 402 that system 100 may provide for display in certain implementations. As shown in FIG. 4, live preview image 402 is provided for display on a display screen of a mobile computing device 404, which corresponds to a smartphone in the example shown in FIG. 4. Live preview image 402 includes an image of ear 304 that is displayed concurrently together with a virtual representation 406 of a customized hearing device. In the example, shown in FIG. 4, image capture device 302 may be included as a front facing camera of mobile computing device 404. With such a configuration, user 306 may hold up mobile computing device 404 to capture a live image of ear 304. While mobile computing device 404 captures and displays the live image, virtual representation 406 is provided for display in live preview image 402 at a position where the customized hearing device represented by virtual representation 406 would be worn by the user. In addition, the size of virtual representation 406 within live preview image 402 accurately represents how big the customized hearing device will be in relation to ear 304. Accordingly, user 306 may easily see, in real time, how large the customized hearing device represented by virtual representation 406 will be in relation to ear 304 prior to manufacture of the customized hearing device.

A virtual representation may be provided for display within a live preview image in any suitable manner. For example, virtual representation 406 shown in FIG. 4 may be overlaid, in any suitable manner, over the live image captured by the front facing camera of mobile computing device 404. Alternatively, an image captured by image capture device 302 (e.g., the front facing camera of mobile computing device 404) may be modified, in any suitable manner, to include a virtual representation of a customized hearing device.

In certain examples, system 100 may provide a live preview image for display to a user as a live augmented reality (AR) preview image. The live AR preview image may include a virtual representation of a customized hearing device and a live image captured of the user's ear. With such a configuration, the user may be able to adjust the viewing angle of the live AR preview image in real time in any suitable manner to see how a virtual representation of a customized hearing device would appear from any one of a plurality of different angles.

In certain examples, system 100 may facilitate a user selectively switching from viewing a live preview image that includes a first virtual representation of a first customized hearing device to a live preview image that includes a second virtual representation of a second customized hearing device. This may be accomplished in any suitable manner. For example, system 100 may provide one or more icons for display by way of a graphical user interface that are selectable by a user to change which virtual representation is currently displayed by way of a display device. System 100 may detect a user selection of one of the icons in any suitable manner. For example, system 100 may detect a touch input with respect to an icon. In response to the user selection, system 100 may provide for display to a user the second live preview image including the second virtual representation of the second customized hearing device instead of the first virtual representation of the first customized hearing device.

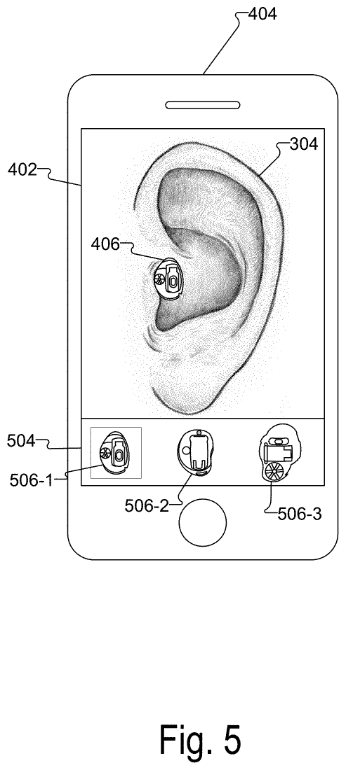

To illustrate an example, FIG. 5 shows an exemplary implementation in which live preview image 402 is provided for display on a display screen of mobile computing device 404 together with a graphical user interface section 504 that includes icons 506 (e.g., icons 506-1 through 506-3). As shown in FIG. 5, each icon 506 corresponds to a graphical depiction of a customized hearing device that has a different shape, size, and/or configuration. In the example shown in FIG. 5, virtual representation 406 corresponds to icon 506-1. The box around icon 506-1 indicates that the virtual representation associated with icon 406 is currently displayed in live preview image 402. While virtual representation 406 is displayed in live preview image 402, a user may provide any suitable user input (e.g., a touch input) with respect to icon 506-2 to view how a virtual representation associated with icon 506-2 would appear in relation to ear 304. In response to the user selection of icon 506-2, system 100 may display a virtual representation associated with icon 506-2 in live preview image 402 instead of virtual representation 406. In the example shown in FIG. 5, the virtual representation associated with icon 506-3 is relatively larger than the virtual representations associated with icons 506-1 and 506-2. This may be due, at least in part, to a relatively larger volume adjustment dial and/or other components that are to be included as part of the customized hearing device associated with icon 506-3. Through icons 506, a user may be able to easily switch between virtual representations and readily visualize how different configurations may affect the size and/or shape of customized hearing devices. In so doing, system 100 may facilitate users making an informed decision regarding which customized hearing device is best suited for them.

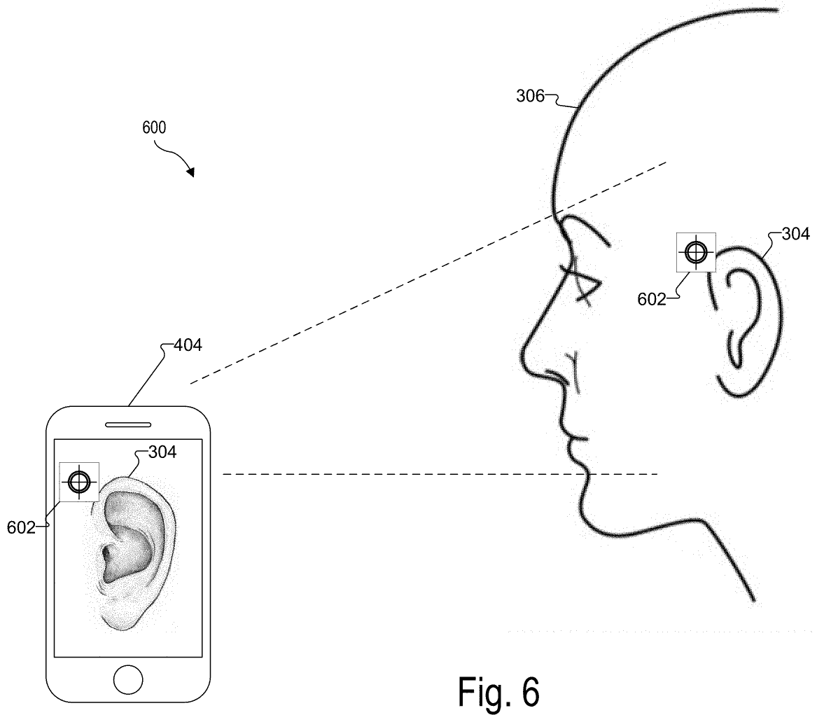

In certain examples, system 100 may be configured to capture an image of a reference scale indicator together with an image of an ear of a user. Such a reference scale indicator may be used as a reference point to determine how far an image capture device is from a user and at which angle compared to the user. System 100 may use such information to facilitate determining a relative size and/or angle that a virtual representation should be provided for display in a live preview image in relation to an ear of a user. In examples where an image capture device is provided in a mobile computing device, a gyroscope of the mobile computing device may be used in any suitable manner to facilitate determining the angle of the mobile computing device with respect to the ear of the user. A reference scale indicator may have any suitable configuration as may serve a particular implementation. For example, a reference scale indicator may be attached (e.g., by way of a sticker) to a cheek of a user. To illustrate, FIG. 6 shows an exemplary configuration 600 in which mobile computing device 404 is being used to capture an image of ear 304 and a reference scale indicator 602. In the example shown in FIG. 6, reference scale indicator 602 is shown as a having orthogonally intersecting lines and two concentric circles. However, it is understood that a reference scale indicator may have any other suitable configuration as may serve a particular implementation.

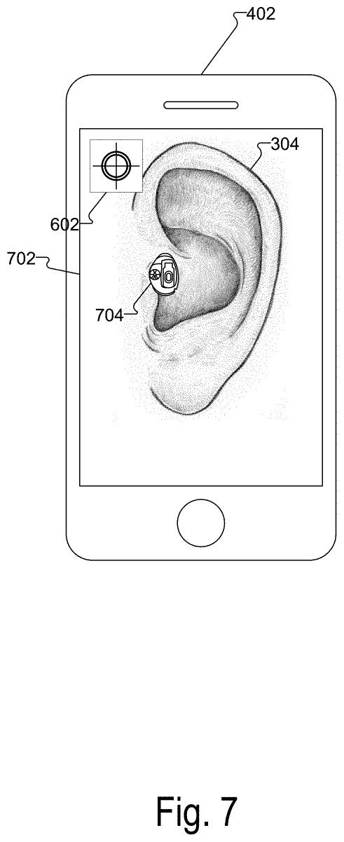

FIG. 7 shows an exemplary live preview image 702 that includes virtual representation 704 provided for display together with ear 304 of user 306. As shown in FIG. 7, reference scale indicator 602 is also included as part of live preview image 702 as a result of being in the image captured by the front facing camera of mobile computing device 404.

Although FIGS. 4, 5, and 7 show examples of a virtual representation being provided for display on mobile computing device 404. It is understood that a virtual representation of a customized hearing device may be provided for display on any other suitable display device in certain implementations. For example, in certain implementations, a live preview image including a virtual representation of a customized hearing device may be provided for display by way of a laptop computer, a desktop monitor, or any other suitable display device while an image capture device (e.g., a camera of mobile computing device 404) captures a live image of ear 304.

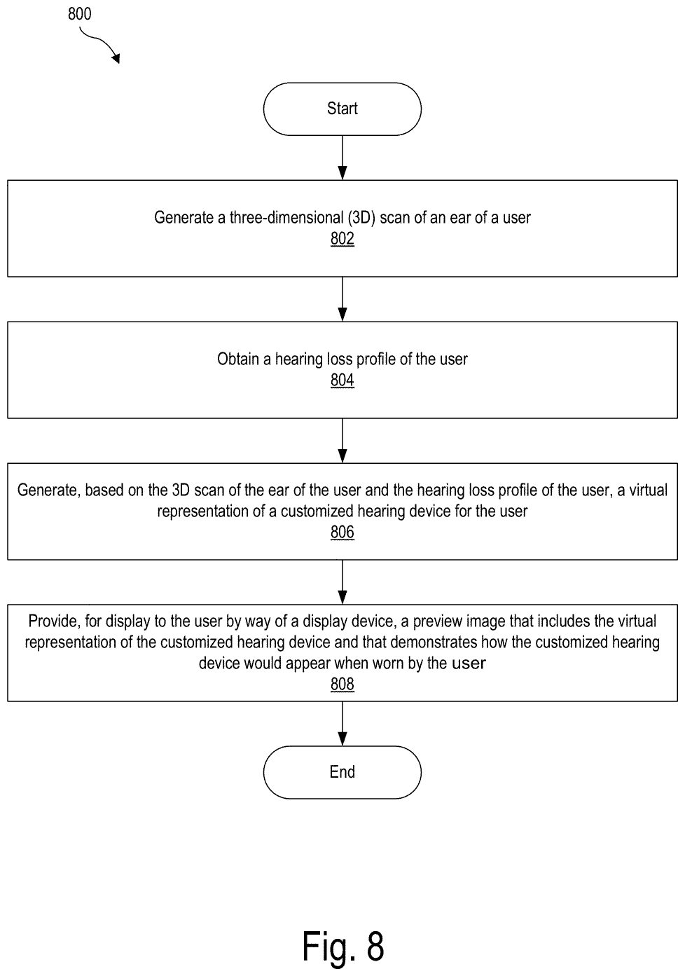

FIG. 8 illustrates an exemplary method for facilitating a virtual preview of a visual appearance of a customized hearing device. While FIG. 8 illustrates exemplary operations according to one embodiment, other embodiments may omit, add to, reorder, and/or modify any of the operations shown in FIG. 8. One or more of the operations shown in FIG. 8 may be performed by a system such as system 100, any components included therein, and/or any implementation thereof.

In operation 802, a processor (e.g., processor 104) may generate a 3D scan of an ear of a user. Operation 802 may be performed in any of the ways described herein.

In operation 804, the processor may obtain a hearing loss profile of the user. Operation 804 may be performed in any of the ways described herein.

In operation 806, the processor may generate, based on the 3D scan of the ear of the user and the hearing loss profile of the user, a virtual representation of a customized hearing device for the user. Operation 806 may be performed in any of the ways described herein.

In operation 808, the processor may provide, for display to the user by way of a display device, a preview image that includes the virtual representation of the customized hearing device and that demonstrates how the customized hearing device would appear when worn by the user. Operation 808 may be performed in any of the ways described herein.

Although the examples set forth herein are described in the context of providing a virtual preview of a customized hearing device, it is understood that principles and concepts such as those described herein may be applied in other contexts in other implementations. For example, principles and concepts such as those described herein may be used in certain implementations to provide a virtual preview of how custom earbuds would appear on a user. In such examples, a virtual representation of customized earbuds may not be generated based on a hearing loss profile of a user.

In certain alternative examples, principles and concepts such as those described herein may be used in certain examples to provide a virtual preview of how a customized health monitoring device would appear when worn by a user. Such a customized health monitoring device may be configured to monitor any suitable physiological attribute or combination of physiological attributes that may be associated with a user. For example, a physiological attribute may comprise a hydration level associated with the user (e.g., within the ear canal of the user), brain activity indicated in an electroencephalogram (“EEG”) measurement, a heartbeat attribute indicated in an electrocardiogram (“ECG”) measurement, any attribute associated with a disease (e.g., diabetes), and/or any other suitable physiological attribute. In such examples, a virtual representation of customized health monitoring device may be generated based on a health profile of a user as opposed to a hearing loss profile of the user.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g. a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

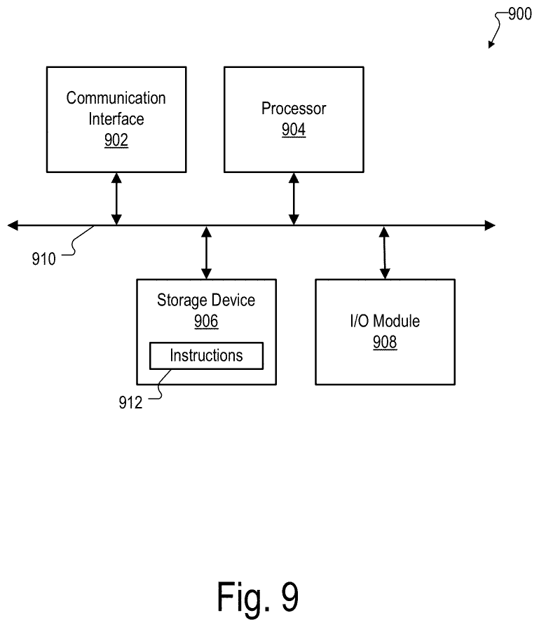

FIG. 9 illustrates an exemplary computing device 900 that may be specifically configured to perform one or more of the processes described herein. As shown in FIG. 9, computing device 900 may include a communication interface 902, a processor 904, a storage device 906, and an input/output (“I/O”) module 908 communicatively connected one to another via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data and/or interpreting, executing, and/or directing execution of one or more of the instructions, processes, and/or operations described herein. Processor 904 may perform operations by executing computer-executable instructions 912 (e.g., an application, software, code, and/or other executable data instance) stored in storage device 906.

Storage device 906 may include one or more data storage media, devices, or configurations and may employ any type, form, and combination of data storage media and/or device. For example, storage device 906 may include, but is not limited to, any combination of the non-volatile media and/or volatile media described herein. Electronic data, including data described herein, may be temporarily and/or permanently stored in storage device 906. For example, data representative of computer-executable instructions 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. One or more I/O modules may be used to receive input for a single virtual experience. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In some examples, any of the systems, hearing devices, and/or other components described herein may be implemented by computing device 900. For example, memory 102 may be implemented by storage device 906, and processor 104 may be implemented by processor 904.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A system comprising:
a memory storing instructions; and
a processor communicatively coupled to the memory and configured to execute the instructions to:
generate a three-dimensional (3D) scan of an ear of a user;
obtain a hearing loss profile of the user;
generate, based on the 3D scan of the ear of the user and the hearing loss profile of the user, a virtual representation of a customized hearing device for the user; and
provide, for display to the user by way of a display device and prior to manufacture of the customized hearing device, a live preview image that includes an external view of the user's head and the virtual representation of the customized hearing device such that the live preview image demonstrates how the customized hearing device would appear when worn by the user.

2. The system of claim 1, wherein the generating of the 3D scan of the ear of the user includes 3D scanning an impression of the ear of the user.

3. The system of claim 2, wherein the impression is formed by inserting shape-forming material into an ear canal of the user.

4. The system of claim 1, wherein the generating of the 3D scan of the ear of the user includes directly 3D scanning the ear of the user.

5. The system of claim 4, wherein the 3D scanning includes 3D scanning inside an ear canal of the user.

6. The system of claim 1, wherein the virtual representation of the customized hearing device includes at least one of a virtual representation of an in-the-ear component and a virtual representation of a behind-the-ear component.

7. The system of claim 1, wherein the generating of the virtual representation of the customized hearing device includes:
identifying, based on the hearing loss profile of the user, one or more components that are to be included in the customized hearing device; and
determining, based on the one or more components, a size of the virtual representation of the customized hearing device relative to the ear of the user.

8. The system of claim 1, wherein the processor is further configured to execute the instructions to:
instruct an image capture device to capture an image of the ear of the user; and
provide the image of the ear of the user to the display device for display to the user together with the virtual representation of the customized hearing device to generate the live preview image.

9. The system of claim 8, wherein the image of the ear of the user includes an image of a reference scale indicator that is provided on the user and that is usable to determine at least one of a distance of the image capture device from the user and an angle of the image capture device with respect to the user.

10. The system of claim 1, wherein the preview image is a live augmented reality preview image that includes the virtual representation of the customized hearing device and that demonstrates how the customized hearing device would appear from any one of a plurality of different angles when worn by the user.

11. The system of claim 1, wherein the generating of the virtual representation of the customized hearing device includes generating a plurality virtual representations of customized hearing devices for the user.

12. The system of claim 11, wherein the processor is further configured to execute the instructions to:
provide, for display to the user by way of the display device, an icon representative of an additional virtual representation of an additional customized hearing device included in the plurality of virtual representations of customized hearing devices;
detect a user selection of the icon; and
provide, for display to the user by way of the display device in response to the user selection of the icon and in place of the preview image, an additional preview image that includes the additional virtual representation of the additional customized hearing device and that demonstrates how the additional customized hearing device would appear when worn by the user.

13. A method comprising:
generating, by a processor, a three-dimensional (3D) scan of an ear of a user;
obtaining, by the processor, a hearing loss profile of the user;
generating, by the processor and based on the 3D scan of the ear of the user and the hearing loss profile of the user, a virtual representation of a customized hearing device for the user; and
providing, by the processor for display to the user by way of a display device and prior to manufacture of the customized hearing device, a live preview image that includes an external view of the user's head and the virtual representation of the customized hearing device such that the live preview image demonstrates how the customized hearing device would appear when worn by the user.

14. The method of claim 13, further comprising:
generating, by the processor, an indicator that is usable to access information associated with the virtual representation of the customized hearing device; and
providing, by the processor, the indicator for display by way of an additional display device.

15. The method of claim 14, wherein:
the indicator is configured to be scanned by a mobile computing device; and
the live preview image provided for display by way of the display device is provided for display by way of a display device of the mobile computing device based on the information associated with the virtual representation of the customized hearing device accessed from the indicator.

16. The method of claim 13, wherein the virtual representation of the customized hearing device includes at least one of a virtual representation of an in-the-ear component and a virtual representation of a behind-the-ear component.

17. The method of claim 13, wherein the generating of the virtual representation of the customized hearing device includes generating a plurality virtual representations of customized hearing devices for the user.

18. The method of claim 17, further comprising:
providing, by the processor for display to the user by way of the display device, an icon representative of an additional virtual representation of an additional customized hearing device included in the plurality of virtual representations of customized hearing devices;
detecting, by the processor, a user selection of the icon; and
providing, by the processor for display to the user by way of the display device in response to the user selection of the icon, the additional virtual representation of the additional customized hearing device concurrently together with the live image instead of the virtual representation of the customized hearing device to demonstrate how the additional customized hearing device would appear when worn by the user.

19. The method of claim 13, further comprising directing, by the processor, an image capture device of a mobile computing device to obtain a live image of the ear of the user.

20. A non-transitory computer readable storage medium storing instructions that, when executed, direct a processor to:
generate a three-dimensional (3D) scan of an ear of a user;
obtain a hearing loss profile of the user;
generate, based on the 3D scan of the ear of the user and the hearing loss profile of the user, a virtual representation of a customized hearing device for the user; and
provide, for display to the user by way of a display device and prior to manufacture of the customized hearing device, a live preview image that includes an external view of the user's head and the virtual representation of the customized hearing device such that the live preview image demonstrates how the customized hearing device would appear when worn by the user.

21. The system of claim 1, wherein the external view of the user's head represented in the live preview image includes an entirety of the ear of the user.
